(19) United States
(12) Patent Application Publication
(10) Pub. No.: US 2015/0209880 A1
(43) Pub. Date: Jul. 30, 2015

(54) Assembly to Operate a Reciprocating Saw Blade From a Rotating Shaft

(71) Applicant: Michel Letendre, St-Hubert (CA)

(72) Inventor: Michel Letendre, St-Hubert (CA)

(21) Appl. No.: 14/417,064

(22) PCT Filed: Jul. 25, 2013
(86) PCT No.: PCT/CA2013/000671

§ 371 Date: Jan. 23, 2015

Related U.S. Application Data
(60) Provisional application No. 61/677,133, filed on Jul. 30, 2012.

(51) Int. Cl. B23D 51/20

(52) U.S. Cl. CPC B23D 51/20

(57) ABSTRACT

An assembly to mount a reciprocating saw blade to a rotating shaft is described herein. The assembly includes first and second coupling elements for receiving the reciprocating saw blade, wherein said elements are rotatably coupled and reversely driven in unison by the rotating shaft of the table saw, said elements both rotating at the same angular speed along respective circular paths of different radii. The assembly being mounted underneath the table saw top so that i) a first coupling element which is furthermost away from the table saw top is movable along a larger circle than the other coupling element and ii) the line intersecting both circular paths during rotation of the first and second coupling elements converges at a fixed position above the table saw top so that the upper side of a panel is cut during the downstroke of the saw blade, and the bottom side of the panel is out during the upstroke of the saw blade, thereby minimizing chipping of the panel cut edges.

### FIELD

The present invention generally relates to saws. More specifically, the present invention is concerned with an assembly allowing a reciprocating saw blade to be operatively mounted on a rotating shaft, for example on the rotating shaft of a conventional table saw.

### BACKGROUND

Various devices have been designed to cut melamine-type covered panels (hereinafter “melamine panels”) on a table saw without chipping the edges of the cut on either side of the melamine panel, which normally occurs when the teeth of the saw blade exit the cut.

While these devices may deliver adequate quality cuts, they have proved costly and difficult to adjust, in particular when the blades need resharpening.

On the other hand, conventional reciprocating saws, which are less expensive to manufacture and operate than for example circular saw blades, are currently unusable to cut melamine since they cause the above-mentioned chipping of the edges.

### SUMMARY

An object is to provide an assembly for operating a reciprocating saw blade through a rotary shaft, for example on the rotating shaft of a conventional table saw.

The problem of chipping the edges of the cut on both sides of a melamine panel when using a reciprocating saw blade is solved by varying the angle of the blade depending upon both its position and moving direction relative to the panel so that when the blade teeth are entering a surface of the panel, the blade teeth are pushing the surface of the panel towards the interior thereof.

In accordance with an illustrated embodiment, there is provided an assembly for operating a reciprocating saw blade through a rotating shaft of a table saw, the assembly comprising:

first and second coupling elements for receiving the saw blade, wherein the first and second coupling elements are rotatably coupled to the rotating shaft of the table saw for rotation in unison therewith and at a same angular speed along respective different radii and paths; the assembly being mounted to a table of the table saw so that i) one of the first and second coupling elements which is furthermost away from the table is movable along a larger circle than the other coupling element and ii) lines intersecting both circular paths during rotation of the first and second coupling elements converge at a fixed position above the table;

whereby, in operation, the reciprocating saw blade is caused by the rotating shaft to reciprocate relative to the table with an angle that varies with a reciprocating direction of the saw blade relative to the table; the angle remaining acute relative to a corresponding one of a top and bottom surfaces of the table towards which the blade moves.

According to some embodiments, there is provided an assembly to mount a reciprocating saw blade to a rotating shaft, the assembly comprising:

a first sprocket provided with a first offset pin;

a second sprocket provided with a second and different offset pin;

a flexible link interconnecting both the first and second sprockets;

a saw blade holding assembly provided with a first circular mounting aperture and a second elongated mounting aperture; the first and second mounting apertures being respectively associated with the first and second offset pins;

wherein a) a reciprocating saw blade is mountable to the now blade holding assembly; and b) rotational movement of the flexible link causes upstroke and downstroke movements of the saw blade holding assembly.

Other objects, advantages and features of the present invention will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a schematic side elevation of an assembly for operating a reciprocating saw according to a first illustrative embodiment;

FIGS. 2 to 8 illustrate the assembly of FIG. 1 in operation;

FIG. 9 is a schematic side elevation of an assembly for operating a reciprocating saw blade according to a second illustrative embodiment;

FIG. 10 is a front elevation view of the assembly of FIG. 9; and

FIG. 11 is a top plan view of the assembly of FIG. 9.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

The expression “connected” should be construed herein and in the appended claims broadly so as to include any cooperative or passive association between mechanical parts or components. For example, such parts may be assembled together by direct coupling, or indirectly coupled using further parts. The coupling can also be remote, using for example a magnetic field or else.

Other objects, advantages and features of the assembly to mount a reciprocating saw blade to a table saw will become more apparent upon reading of the following non-restrictive description of illustrative embodiments thereof, given by way of example only with reference to the accompanying drawings.

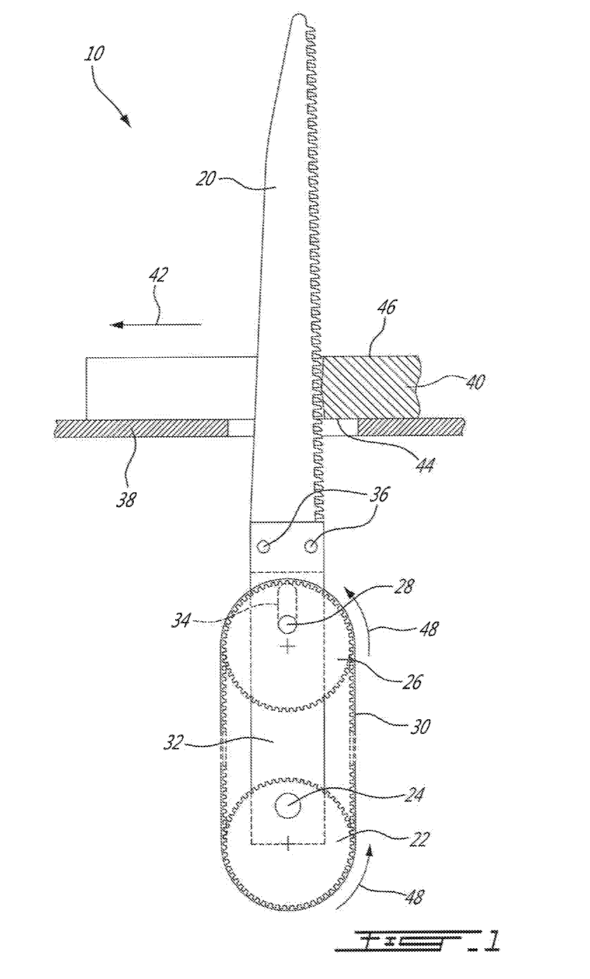

FIG. 1 schematically illustrates an assembly 10 for operating a reciprocating saw blade 20 through a rotating shaft, such as the shaft (not shown) of a table saw (not shown), for example.

The assembly 10 includes a first sprocket 22 provided with an offset mounting point in the form of a pin 24, a second sprocket 26 having the same number of teeth as the first sprocket 22 and provided with a different offset mounting point in the form of a in 28 and a flexible link in the form of a timing type belt 30 interconnecting the first and second sprockets 22 and 26. The first sprocket 22 is fixedly mounted to the rotating shaft so that both the first and second sprockets 22 and 26 are rotatably coupled to the rotating shaft for rotation in unison therewith. A sprocket support (not shown) is provided to rotatably receive both first and second sprockets 22 and 26.

According to another embodiment (not shown), the link 30 is replaced by a gear assembly that interconnects the first and second sprockets 22 and 26 for rotation in unison.

A saw blade holding assembly 32 is mounted to both the pins 24 and 28 of the first and second wheels 22 and 26. More specifically, the holding assembly 32 is pivotally mounted to the first pin 24, for example via C-clips (not shown) and pivotally and slidably mounted to the second pin 28 also via C-clips (not shown). More specifically, a cylindrical aperture (not shown) of the holding assembly 32 is used to mount the assembly to the first wheel 22 and an elongated aperture 34 is used to mount the assembly to the second wheel 26.

The reciprocating saw blade 20 is mounted to the saw blade holding assembly 32 via two fasteners 36.

The first and second sprockets 22 and 26, with their corresponding pins 24 and 28 respectively define first and second coupling elements for receiving the saw blade 20.

Both mounting pins 24 and 28 being offset from the rotation axis of their respective sprocket 22 and 26, the rotation of the rotating shaft causes the pins 24 and 28 to move along circular paths at the same radial speed. The first pin 24 being more severely shifted away from the rotational axis of its sprocket 22, the radius defined by its path (not shown) is greater than the radius defined by the path of the second pin 28.

According to another embodiment (not shown), the holding assembly 32 is omitted and the saw blade 20 is configured with rounded and elongated holes to be directly mounted to the first and second sprockets 22 and 26.

According to still another embodiment, the saw blade 20 or the holding assembly 32 includes two pins and the sprockets are provided with respective rounded and elongated apertures to receive the pins and to allow the pins to move along circular paths upon rotation of a rotating shaft operatively coupled to both sprockets as described hereinabove.

FIG. 1 shows the assembly 10 mounted under the table 38 of a table saw and being in the process of cutting a melamine panel 40 moving in the direction of arrow 42. The panel 40 has a first face 44 sliding against the table top 38 and a second face 46 opposite and parallel to the first face 44.

Other characteristics and features of the assembly 10 will become more apparent upon reading the following description of the operation thereof, with references to FIGS. 1 to 8.

As can be seen from FIG. 1, both wheels rotate counterclockwise (see arrows 48) at the same angular speed.

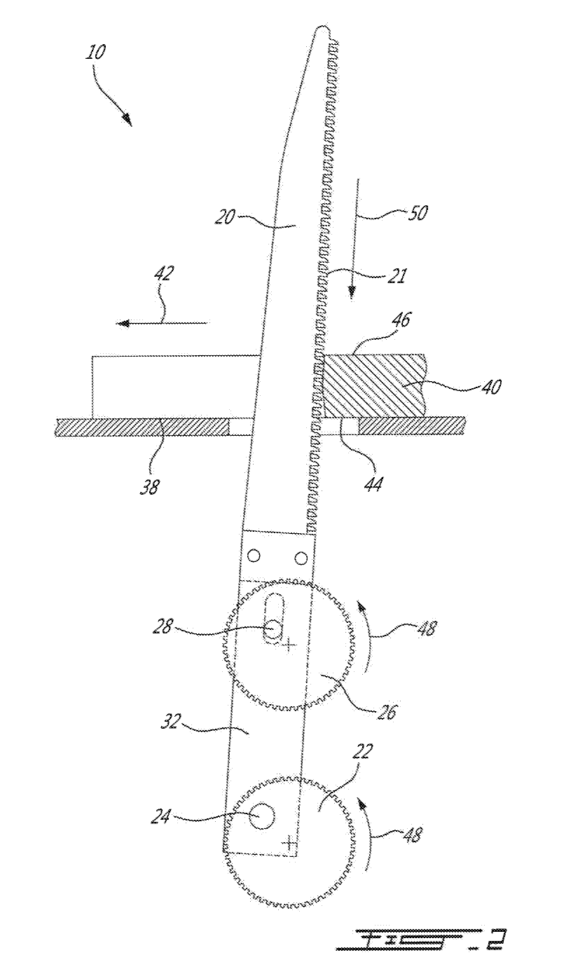

FIG. 2 shows the assembly 10 when one eighth of a full rotation has been done. Since the holding assembly 32 is pivotally mounted to wheel 22, rotation of said wheel 22 causes a downward movement of the blade 20 (see arrow 50). Since the offset of pin 24 is more severe than the offset of pin 28, the saw blade 20 is angled towards the uncut portion of the panel 40 while it goes down. This angle of the blade 20 ensures that the teeth 21 thereof are only in contact with the second face 46 of the panel and do not contact the first face 44 during the downstroke.

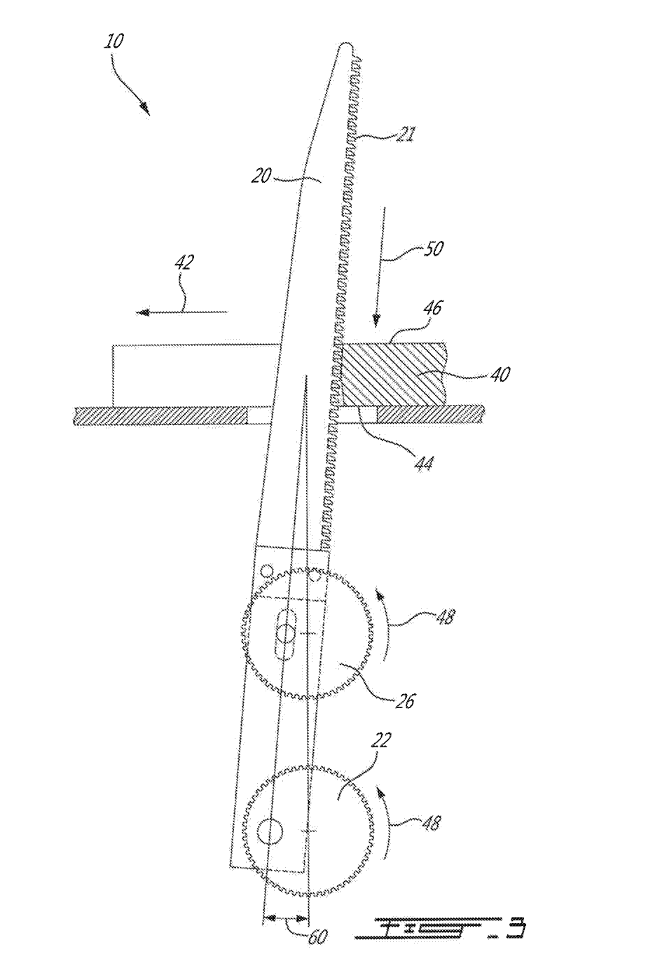

FIG. 3 illustrates the assembly 10 when one quarter of a full rotation has been done. When the assembly is in this position, the angle 60 between the longitudinal axis of the saw blade 20 and the vertical axis is near maximum. It will be appreciated to one skilled in the art that the intersection of both the vertical and the longitudinal axis of the saw blade 20 is at all time located about in the middle of the panel 40. In other words, during rotation of the sprockets 22 and 26, the line that intersects both pins 24 and 28 crosses at a fixed position regardless of the angular position of respective pins 24 and 28. The saw blade 20 is so mounted to the assembly 10, and the assembly 10 is so positioned relative the table 38 and, considering the predetermined thickness of the panel 40, that the saw blade 20 contacts only one face of the panel 40 at any given time.

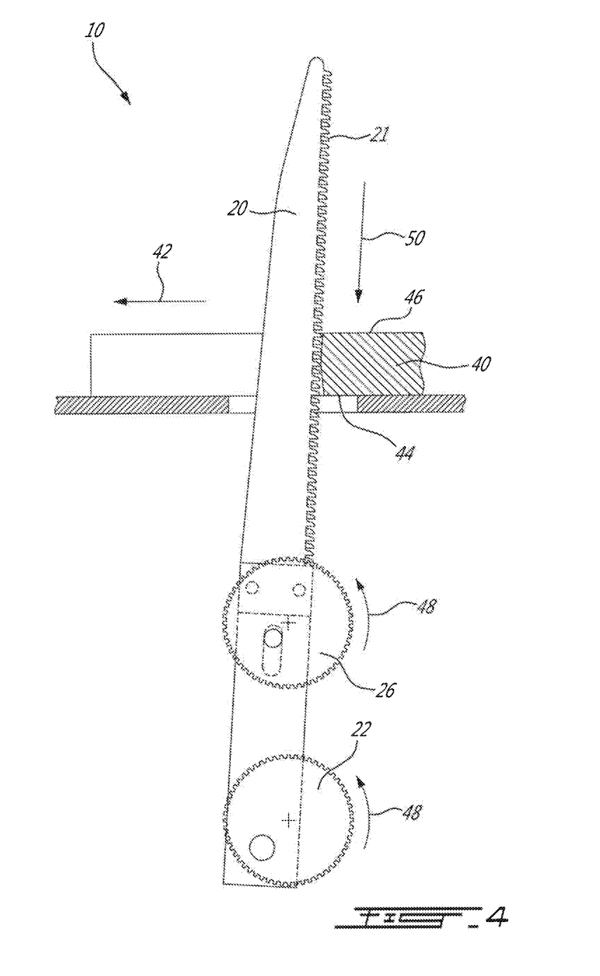

In FIG. 4, three eights of a full rotation has been done and the blade 20 is getting close to the vertical.

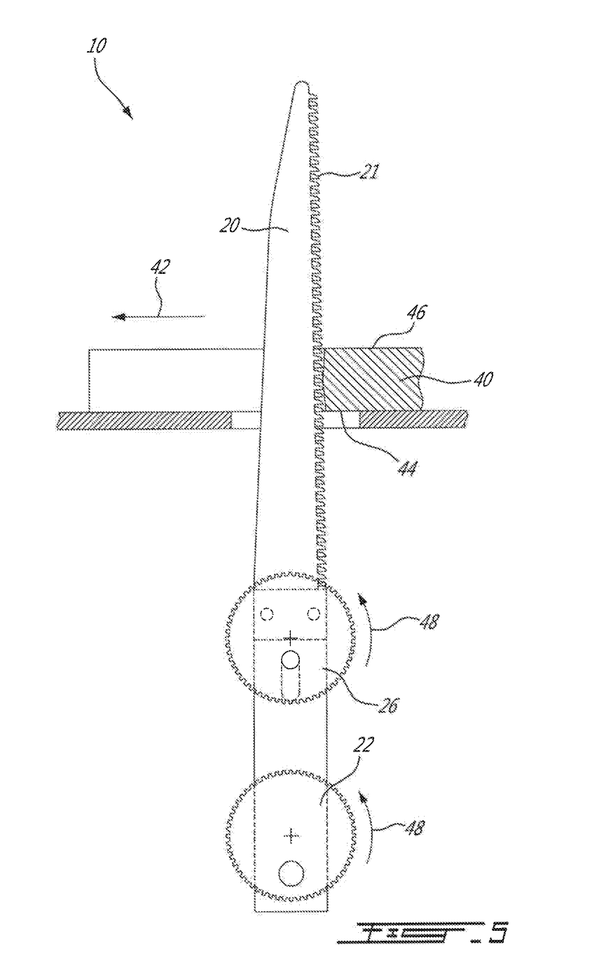

When half a turn has been done, as shown in FIG. 5, the saw blade 20 is vertical. As can be seen from this figure, the teeth 21 of the blade 20 do not contact either surfaces of the panel 40.

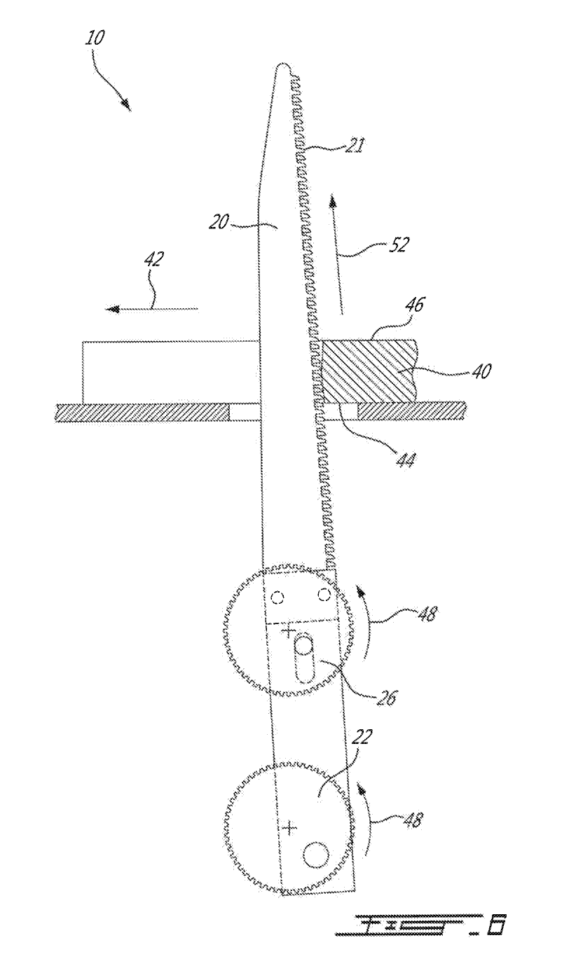

FIG. 6 illustrates the beginning of the upstroke of the saw blade 20 (see arrow 52). Again, since the offset of pin 24 is more severe than the offset of pin 28, the saw blade 20 is angled away from the uncut portion of the panel 40 while it goes up. This angle of the blade 20 ensures that the teeth 21 thereof are only in contact with the first face 44 of the panel and do not contact the second face 46 during the upstroke.

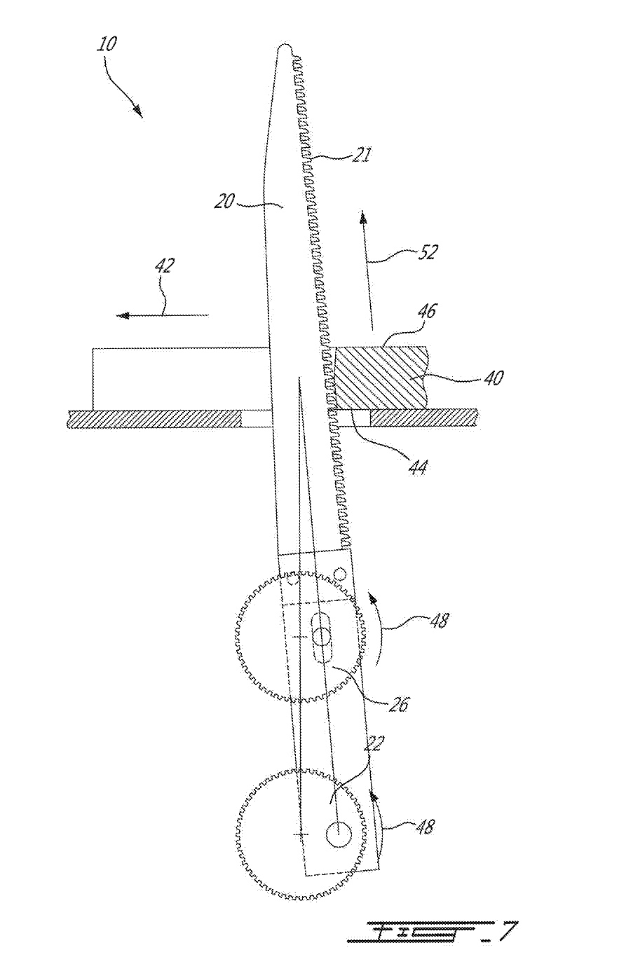

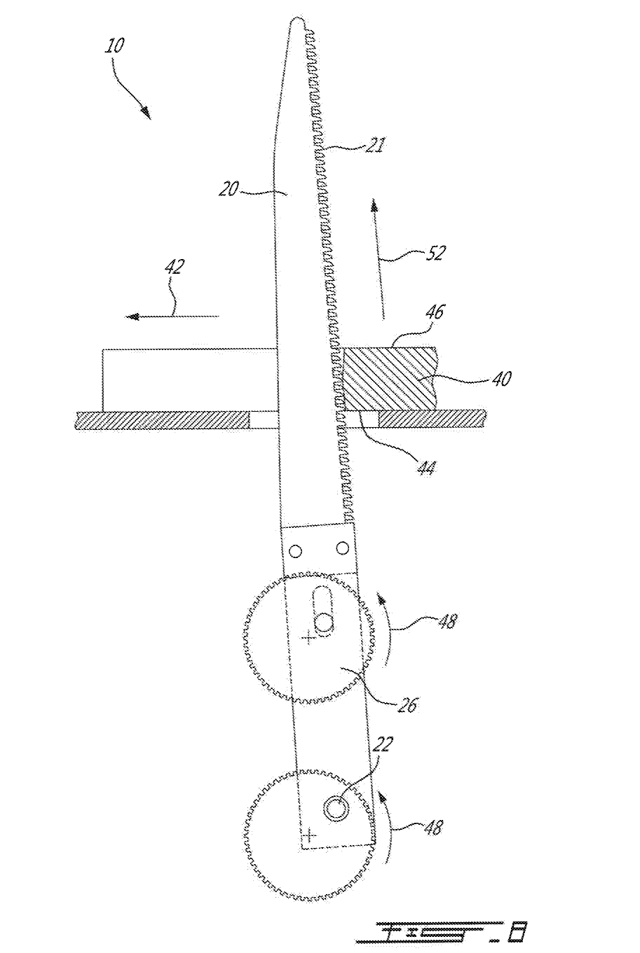

FIGS. 7 and 8 complete the upstroke.

The sequence of movements schematically illustrated in FIGS. 1 to 8 are repeated for each rotation of the rotating shaft (not shown) to which the assembly is mounted until the panel 40 has been cut. During a full rotation of the rotating shaft, the movement of the saw blade 20 is such that its teeth always touch faces 44 and 46 in a favorable moving direction, which is to push the panel faces towards the interior thereof.

One skilled in the art will understand that the saw blade extends from the table with an angle that varies according to the reciprocating direction of the saw blade, so that the angle remains acute relative to a corresponding one of a top and bottom surfaces of the table towards which the blade moves, i.e. the second face 46 during the downstroke and the first face 44 during the upstroke. This results in the surface layers on both sides of the melamine panel being cleanly cut without being chipped.

One skilled in the art will understand that the mounting means used to mount the reciprocating saw blade 20 to the mounting assembly 32, such as the fasteners 36, could be different depending upon the type of reciprocating saw blade used.

Many saw blade tooth geometry can be used. As a non-limiting example, the reciprocating saw blade commercialized by the company Bosch, under model number T234X has been found adequate.

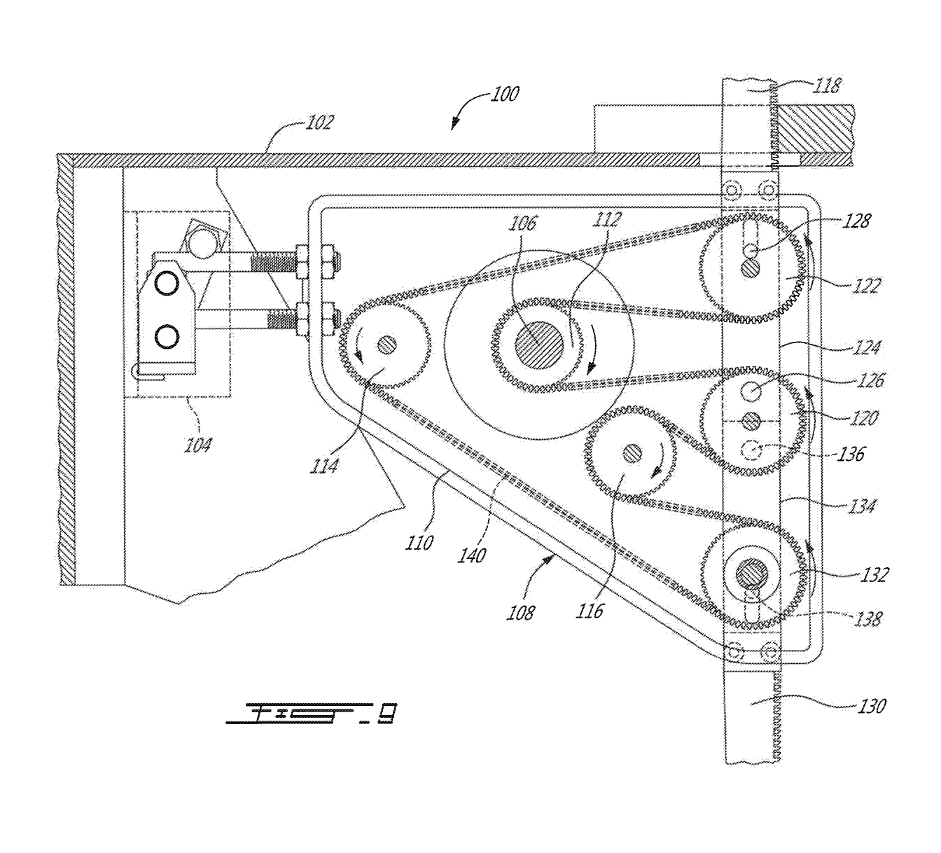

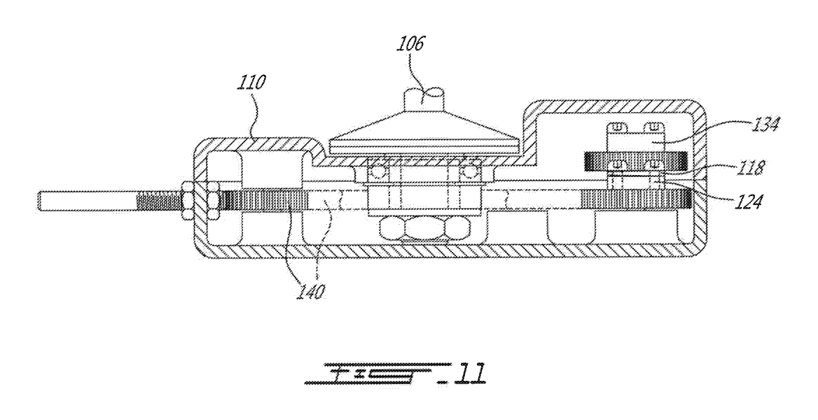

Turning now to FIGS. 9 to 11 of the appended drawings, an assembly 108 for operating a reciprocating saw blade 118 through rotating shaft 106 of a table saw 100 according to a second illustrative embodiment be described.

The table saw 100 includes a table top 102, a table saw shaft 106, reversely driving sprockets 120, 122, and 132, and a stabilizing spring type bracket 104.

The assembly 108 to operate a reciprocating saw blade through a rotating shaft 106 includes a frame 110, a driving sprocket 112 mounted on the table saw shaft 106, idler sprockets 114 and 116, a reciprocating saw blade 118 mounted to an assembly similar to the one described with reference to FIGS. 1 to 8, i.e. including first and second sprockets 120, 122 supporting a blade holder 124 via respective pins 126 and 128. A counterbalancing saw blade 130 is mounted opposite the cutting saw blade 118 via the first and a third sprockets 120 and 132 via a blade holder 134 mounted to respective pins 136 and 138 thereof. A flexible link such as a double sided timing type belt 140 interconnects the various sprockets.

One skilled in the art will understand that the assembly 108 operates as described hereinabove with reference to FIGS. 1 to 8. However, the purpose of the counterbalancing blade 130 is to minimize the vibration potentially caused by the upstroke/downstroke movements of the cutting blade 118.

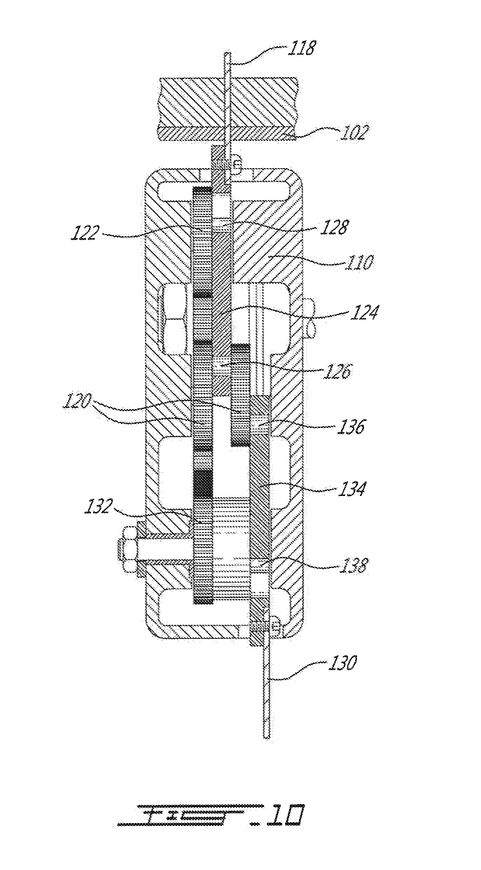

As is apparent from FIG. 10, the blade holders 124 and 134 respectively supporting the saw blades 118 and 130 are positioned on either sides of the sprocket 120 to prevent interference therebetween.

Also from FIG. 10, the frame 110 includes sidewalls with apertures designed to mount the various sprockets thereto.

According to another embodiment (not shown), the second saw blade 130 is replaced by another element that counterbalances the first saw blade during operation thereof.

It is to be noted that while the offset attaching points are described hereinabove as pins, other element(s) could be used to mount the saw blade holding assembly to the first and second sprockets while allowing the required pivoting movements therebetween.

One skilled in the art will understand that by using disposable reciprocating saw blades, the user does not have to worry any longer about non negligible resharpening costs as well as cumbersome reinstallation and alignment techniques associated with the use of conventional and well known dual circular scoring saw blade system.

Also, one skilled in the art will appreciate that some of the safety components required in conventional table saws, such as and without limitations, a splitter guard, are irrelevant for a table saw equipped with a reciprocating saw blade as described herein.

Also, the above described assemblies to operate a reciprocating saw blade through rotating shaft are not limited to being used to cut melamine panels only.

It is also to be noted that while the above description and the appended drawings are concerned with mounting a reciprocating saw blade to a table saw, the assembly described herein could also very well be used as an alternative to a band saw, primarily in view of the fact that it would permit cuts in stocks of almost limitless dimension sizes.

It is to be understood that the assembly to mount a reciprocating saw blade to a rotating shaft is not limited in its application to the details of construction and parts illustrated in the accompanying drawings and described hereinabove. The assembly to mount a reciprocating saw blade to a rotating shaft is capable of other embodiments and of being practiced in various ways. It is also to be understood that the phraseology or terminology used herein is for the purpose of description and not limitation. Hence, although the assembly to mount a reciprocating saw blade to a rotating shaft has been described hereinabove by way of illustrative embodiments thereof, it can be modified, without departing from the spirit, scope and nature of the subject invention.

1. An assembly for operating a reciprocating saw blade through a rotating shaft of a table saw, the assembly comprising:
first and second coupling elements for receiving the saw blade, wherein the first and second coupling elements are rotatably coupled to the rotating shaft of the table saw for rotation in unison therewith and at a same angular speed along respective different radii and paths; the assembly being mounted to a table of the table saw so that i) one of the first and second coupling elements which is furthermost away from the table is movable along a larger circle than the other coupling element and ii) lines intersecting both circular paths during rotation of the first and second coupling elements converge at a fixed position above the table;
whereby, in operation, the reciprocating saw blade is caused by the rotating shaft to reciprocate relative to the table with an angle that varies with a reciprocating direction of the saw blade relative to the table; the angle remaining acute relative to a corresponding one of a top and bottom surfaces of the table towards which the blade moves.

2. An assembly as recited in claim 1, wherein the first and second coupling elements are first and second sprockets provided with respective first and second offset pins; the assembly further comprising;
a link interconnecting both the first and second sprockets;
a saw blade holding bracket provided with a first circular mounting aperture and a second elongated mounting aperture; the first and second mounting apertures being respectively associated with the first and second offset pins.

3. An assembly as recited in claim 2, wherein the link includes a flexible timing type belt.

4. An assembly as recited in claim 1, wherein the saw blade is a first saw blade; the first and second coupling elements are configured to receive a counterbalancing element that counterbalances the first saw blade during the operation thereof.

5. An assembly as recited in claim 4, wherein the counterbalancing element is a second saw blade identical to the first saw blade.

6. An assembly as recited in claim 1, wherein the first and second coupling elements are rotatably coupled to the rotating shaft of the table saw so as to be reversely driven thereby.

7. A reciprocating table saw having a reciprocating saw blade extending from a table with a angle that varies with the reciprocating direction of the saw blade so that the angle remains acute relative to a corresponding one of a top and bottom surfaces of the table towards which the blade moves.

8. An assembly to mount a reciprocating saw blade to a rotating shaft, the assembly comprising:
a first sprocket provided with a first offset pin;
a second sprocket provided with a second and different offset pin;
a flexible link interconnecting both the first and second sprockets;
a saw blade holding assembly provided with a first circular mounting aperture and a second elongated mounting aperture; the first and second mounting apertures being respectively associated with the first and second offset pins;
wherein a) a reciprocating saw blade is mountable to the saw blade holding assembly; and b) rotational movement of the flexible link causes upstroke and downstroke movements of the saw blade holding assembly.
